(19) United States
(12) Patent Application Publication
(10) Pub. No.: US 2012/0180139 A1
(43) Pub. Date: Jul. 12, 2012

(54) INFORMATION PROCESSOR

(75) Inventors: Akihiko NISHIOKA, Osaka (JP); Toshiyuki SHIMADA, Hyogo (JP)

(73) Assignee: PANASONIC CORPORATION, Osaka (JP)

(21) Appl. No.: 13/338,361

(22) Filed: Dec. 28, 2011

(30) Foreign Application Priority Data
Jan. 6, 2011 (JP) 2011-001000

(51) Int. Cl. G06F 21/00

(52) U.S. Cl. 726/31

(57) ABSTRACT

An information processor according to the present invention is designed to operate in accordance with a right to use a content that is stored on a first storage medium. The first storage medium has a write-once area on which right-to-use information is writable a limited number of times, and a data area on which data of the content is stored. The information processor includes: a second storage medium; a right-to-use information generating section, which generates right-to-use information indicating whether the first storage medium or the second storage medium holds the right to use the content; and a drive device that writes the right-to-use information on the write-once area.

### BACKGROUND OF THE INVENTION

1. Field of the Invention

The present invention relates to an information processor for use to execute copyright protection generation management on a package medium that stores some kind of content such as an optical disc or a semiconductor storage medium.

2. Description of the Related Art

Various kinds of digital contents, including documents, movies, and programs, which have been put on the market and circulated these days, are stored on a variety of package media, including optical discs such as BDs, DVDs and MOs and other storage media such as SD memory cards. And in order to consolidate the protection of copyright of those digitals contents on such package media, numerous sorts of copyright protection technologies are now available.

Until just recently, the copyright protection technology has usually been applied so as to allow only the owner of a given package medium to use its content by prohibiting any person (including the owner him- or herself) from copying that content.

Recently, however, a new technology has been developed to allow one person to copy and transfer a content from one package medium to another storage medium and then allow the same or a different person to use that copied content on that storage medium. Such a new technology is generally called a “right-to-use-a-content transfer technology”. The right-to-use transfer technology is one of various kinds of copyright protection technologies and its object is also to protect the right of a person who holds the copyright for a content. For example, Japanese Patent Application Laid-Open Publication No. 11-328033 (which will be referred to herein as “Patent Document No. 1” for convenience sake) discloses a conventional right-to-use-a-content transfer technology.

According to Patent Document No. 1, the right to use a content that a first storage medium has held (i.e., that has been set for the first storage medium) is transferred to a second storage medium. After that, when a drive that drives the first storage medium receives a request to retrieve the content, of which the right to use has already been transferred, from an application program, the drive accesses the first storage medium and then notifies the application program that the content is no longer retrievable from the first storage medium. Such an operation can get done by the firmware installed in the drive. In this manner, the right to use a content can be transferred legally without infringing the right of a person who holds the copyright for that content.

According to the right-to-use-a-content transfer technology disclosed in Patent Document No. 1, however, it just determines whether or not a given content can be used by seeing if any right to use has been set for a storage medium. That is to say, that technology pays no attention to, and places no particular limit on, how many times the right to use may be transferred. That is why according to that technology, the right to use could be transferred an unlimited number of times. Then, the right of a person who holds the copyright for the content cannot be protected fully.

### SUMMARY OF THE INVENTION

It is therefore an object of the present invention to provide an information processor that carries out generation management on the right to use a content with attention paid to the number of times that the content can be transferred.

An information processor according to the present invention is designed to operate in accordance with a right to use a content that is stored on a first storage medium. The first storage medium has a write-once area on which right-to-use information is writable a limited number of times, and a data area on which data of the content is stored. The information processor includes: a second storage medium; a right-to-use information generating section, which generates right-to-use information indicating whether the first storage medium or the second storage medium holds the right to use the content; and a drive device that writes the right-to-use information on the write-once area.

If any preceding right-to-use information has already been written on the write-once area, the drive device may write the right-to-use information that has been generated by the right-to-use information generating section on the write-once area without modifying the preceding right-to-use information.

The information processor may further include a memory that retains host information to be allocated to the information processor as its own information. The right-to-use information generating section may generate, based on the host information and the number of times that the right-to-use information has been added to the write-once area, a piece of right-to-use information indicating that the second storage medium holds the right to use the content.

The drive device may be able to retrieve right-to-use information that has been written on the write-once area, and the information processor may further include a decision section that determines, based on the right-to-use information that has been retrieved by the drive device, whether the first storage medium or the second storage medium holds the right to use the content.

The information processor may further include a memory that retains host information to be allocated to the information processor as its own information. The decision section may generate a first value based on the host information, may also generates a second value based on the latest piece of right-to-use information that has been written on the write-once area most lately and the number of times that the right-to-use information has ever been written on the write-once area, may determine whether or not the first and second values agree with each other, and may decide that the information processor itself has gotten the right to use the content if the first and second values agree with each other.

The drive device may be able to retrieve right-to-use information that has been written on the write-once area. The information processor may further include a decision section that determines, based on the number M of pieces of valid right-to-use information that has been retrieved by the drive device, whether the first storage medium or the second storage medium holds the right to use the content.

The information processor may further include a control section that either permits or prohibits playing back the content. The drive device may be able to retrieve right-to-use information that has been written on the write-once area. If the drive device has failed to retrieve the latest piece of the right-to-use information properly, the control section may prohibit playing back the content.

An identifier for identifying the first storage medium unequivocally may be stored on the first storage medium. By using the identifier as well, the right-to-use information generating section may generate the right-to-use information indicating that the second storage medium holds the right to use the content.

The right-to-use information generating section may retain first, second and third functions that have been defined in advance. The right-to-use information generating section may obtain two values by substituting the host information into the first function and by substituting the identifier of the first storage medium and another value indicating the number of times that the right-to-use information has been written on the write-once area into the second function, respectively, and may then substitute those two values into the third function to generate the right-to-use information.

The information processor may further include a control section that either permits or prohibits copying the content onto the second storage medium. If the decision section has decided that the information processor itself has gotten the right to use the content, the control section may permit copying the content onto the second storage medium.

According to the present invention, right-to-use information is generated by a predetermined function that uses, as variables, a first storage medium's ID, the information processor's ID, and the number of times M that the right to use a content has been transferred. That is why generation management can be carried out on the right to use the content with attention paid to the number of times that the content has ever been transferred.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 illustrates a configuration for an information processor 1 as a specific preferred embodiment of the present invention.

FIG. 2 illustrates the format of a write-once area 303 on a first storage medium 30.

FIG. 3A is a schematic representation illustrating an exemplary situation where the right to use is gotten and returned between the first storage medium 30 and multiple information processors 1a to 1c.

Portions (a) through (d) of FIG. 3B illustrate what has been added to the write-once area 303 on the first storage medium 30 in respective situations where the processing steps (a) through (d) shown in FIG. 3A have been performed.

FIG. 4A is a flowchart showing the procedure of generating the right-to-use information to add.

FIG. 4B is a flowchart showing the procedure of the processing of determining, by reference to the right-to-use information that has been written on the write-once area 303 on the first storage medium 30, whether or not its own host device has gotten the right to use now.

FIG. 4C is a flowchart showing the procedure of the processing of determining, by reference to the right-to-use information that has been written on the write-once area 303 on the first storage medium 30, whether or not the right to use has been returned properly.

FIG. 5 is a flowchart showing the procedure in which the host device 20 makes a decision on the right to use a content.

FIG. 6 shows how the information to add will change, and what kind of processing may be performed by the host device, as the right to use is gotten and then returned.

### DETAILED DESCRIPTION OF PREFERRED EMBODIMENTS

In various preferred embodiments of the present invention to be described below, content data is supposed to be stored on a first storage medium and the first storage medium is supposed to hold the right to use that content. However, the right to use the content may be transferred from that storage medium to another storage medium that is built in the information processor. In that case, a phrase “the information processor has the right to use” will sometimes be used in this description to express such a situation.

In a preferred embodiment of an information processor according to the present invention, when the right to use a content is temporarily transferred from the first storage medium to the information processor (which will be referred to herein as a “host device”), right-to-use information is added to the first storage medium. The host device that has gotten the right to use may use the content by copying it onto the second storage medium. Alternatively, the content may also be moved instead of being copied.

Once the right to use a content has been transferred from the first storage medium to a certain host device, no other host device may use (e.g., play back or copy) the same content. However, the host device that has gotten the right to use the content may also give up that right and return it to the first storage medium as well. From the first storage medium to which the right to use has been returned or which still stays in the initial state, every host device can retrieve the content. Still, no host device may copy or use that content.

If the first storage medium has a write-once storage area as at least a part of its storage area, the right-to-use information is written on the write-once area of the first storage medium. The right-to-use information may not be erased from the write-once area. Once the write-once area provided for the first storage medium gets full, no right to use can be transferred anymore. As a result, it is possible to avoid an unwanted situation where the right to use is transferred and returned an unlimited number of times.

In this case, the drive device that reads and writes the right-to-use information and the write-once area do not always have to be hidden. Although the rule for generating the right-to-use information should be hidden in the system, the rule does not always have to be encrypted but may also be a unidirectional function as well. According to this preferred embodiment, the rule is supposed to include a media ID, a host ID and a section number to which information is going to be added.

Hereinafter, preferred embodiments of an information processor according to the present invention will be described with reference to the accompanying drawings.

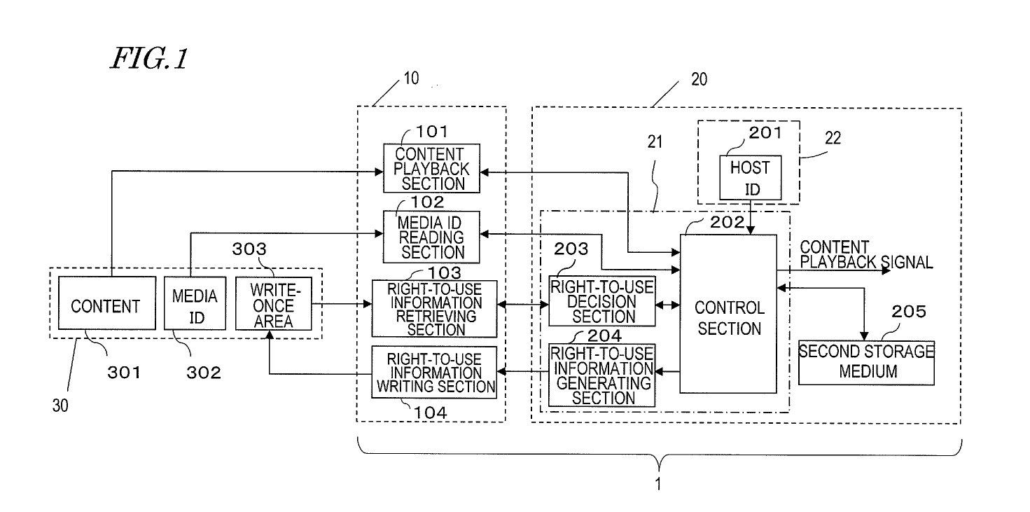

FIG. 1 illustrates a configuration for an information processor 1 as a specific preferred embodiment of the present invention. The information processor 1 includes a drive device 10 and a host device 20. The information processor 1 manages the right to use a content that is stored on a first storage medium 30. In this description, “to manage the right to use a content” means that the information processor 1 determines, by reference to information about the right to use the content that is stored on the first storage medium 30, whether or not the content may be used (i.e., played back or copied) and operates based on a result of the decision. It also means that the information processor 1 that has gotten the right to use the content by itself performs processing concerning the transfer or return of the right to use gotten.

The information processor 1 can read or write information from/on the first storage medium 30.

On the first storage medium 30, stored are a content 301 and a media ID 302 that is non-alterable and is used to identify the first storage medium 30 unequivocally. These data may be stored on the data area of the first storage medium 30, for example. The first storage medium 30 further has a write-once area 303 with a finite area length. Thus, right-to-use information later described can be written a limited number of times.

The first storage medium 30 is a removable storage medium and may be a write-once optical disc (such as a DVD-R) or a semiconductor memory with a write-once area (such as a flash memory card with Programmable Read Only Memory (PROM)).

The drive device 10 reads or writes information from/on the first storage medium 30. If the first storage medium 30 is a write-once optical disc, the drive device 10 is an optical disc drive. On the other hand, if the first storage medium 30 is a semiconductor memory, the drive device 10 is a reader/writer with a slot to which the semiconductor memory is inserted.

The drive device 10 includes a content playback section 101, a media ID reading section 102, a right-to-use information retrieving section 103 and a right-to-use information writing section 104.

The content playback section 101 retrieves the content 301. The media ID reading section 102 reads the media ID 302. The right-to-use information retrieving section 103 retrieves the right-to-use information that has been written on the write-once area 303. And the right-to-use information writing section 104 adds the right-to-use information to the write-once area 303. It should be noted that “to add” some information is different from rewriting the information. If any preceding right-to-use information has already been written on the first storage medium 30, then the right-to-use information writing section 104 writes a new piece of right-to-use information onto the write-once area 303 without modifying the preceding right-to-use information on the first storage medium 30. This is write-once processing.

The host device 20 controls reading and/or writing a content from/on the first storage medium 30 and a second storage medium.

The host device 20 includes a CPU 21, a memory 22 and the second storage medium 205. By executing a computer program, the CPU 21 functions as a control section 202, a right-to-use decision section 203, and a right-to-use information generating section 204 as will be described later. The memory 22 retains a host ID 201, which is a piece of information to be allocated uniquely to the host device 20. The host ID may have been determined when this information processor 1 is shipped, for example.

The right-to-use information generating section 204 generates right-to-use information indicating whether the first storage medium 30 or the second storage medium 205 holds the right to use the content 301.

The control section 202 controls the drive device's write operation and instructs the drive device 10 to write the right-to-use information that has been generated by the right-to-use information generating section 204 onto the write-once area of the first storage medium 30. Also, the control section 202 controls the drive device's read operation and instructs the drive device 10 to retrieve the right-to-use information from the write-once area of the first storage medium 30. The control section 202 also gives the host ID 201 and the media ID 302 to the right-to-use decision section 203.

The right-to-use decision section 203 determines, by reference to the right-to-use information, whether the first storage medium or the second storage medium holds the right to use the content. Also, the right-to-use decision section 203 instructs the right-to-use information retrieving section 103 to retrieve the right-to-use information with the host ID 201 and the media ID 302 and then determines, based on the right-to-use information retrieved, whether or not the content may be played back and whether or not the content that has been copied onto the second storage medium 205 may be used.

The right-to-use information generating section 204 generates the right-to-use information by a predetermined function that uses, as variables, the respective IDs 302 and 201 of the first and second storage media and the number of times M that the right to use the content has been transferred.

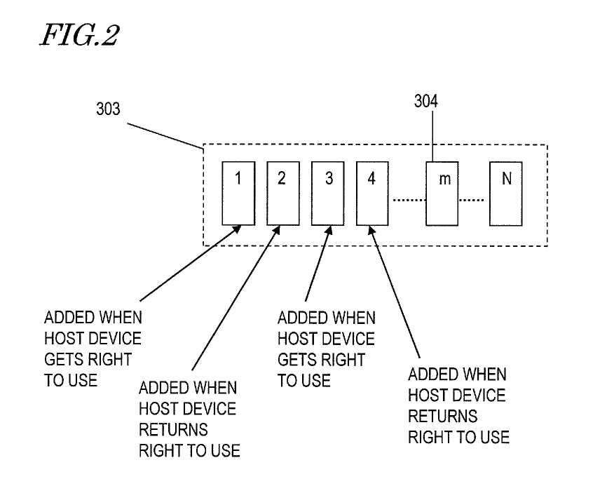

FIG. 2 illustrates the format of the write-once area 303 on the first storage medium 30. The write-once area 303 has N sections 304 to which information can be added. Pieces of the right-to-use-a-content information are added sequentially to those N sections 304 that begin with Section #1. Those pieces of information are added when the information processor either gets or returns the right to use the content. The right to use the content is handled exclusively. If the host device 20 has gotten the right to use the content, the first storage medium 30 has no right to use the same content. Conversely, if the first storage medium 30 has the right to use the content, the host device 20 has no right to use it. That is why the right to use is alternately gotten and returned by the host device 20 and is added to those sections 304 of the write-once area 303. Consequently, if the section number m is an odd number, it indicates that the host device 20 has gotten the right to use. On the other hand, if the section number m is an even number, it indicates that the host device 20 has returned the right to use (i.e., the right to use has been transferred to the first storage medium 30). Also, the section number m (where 1≦m≦N; m: integer) is equivalent to the number of times M that the right to use the content has been transferred.

Although only the first storage medium 30 and the information processor 1 are shown in FIG. 1, this is only an example of the present invention. Optionally, there may be a number of information processors, each of which can play back the content that is stored on the first storage medium 30.

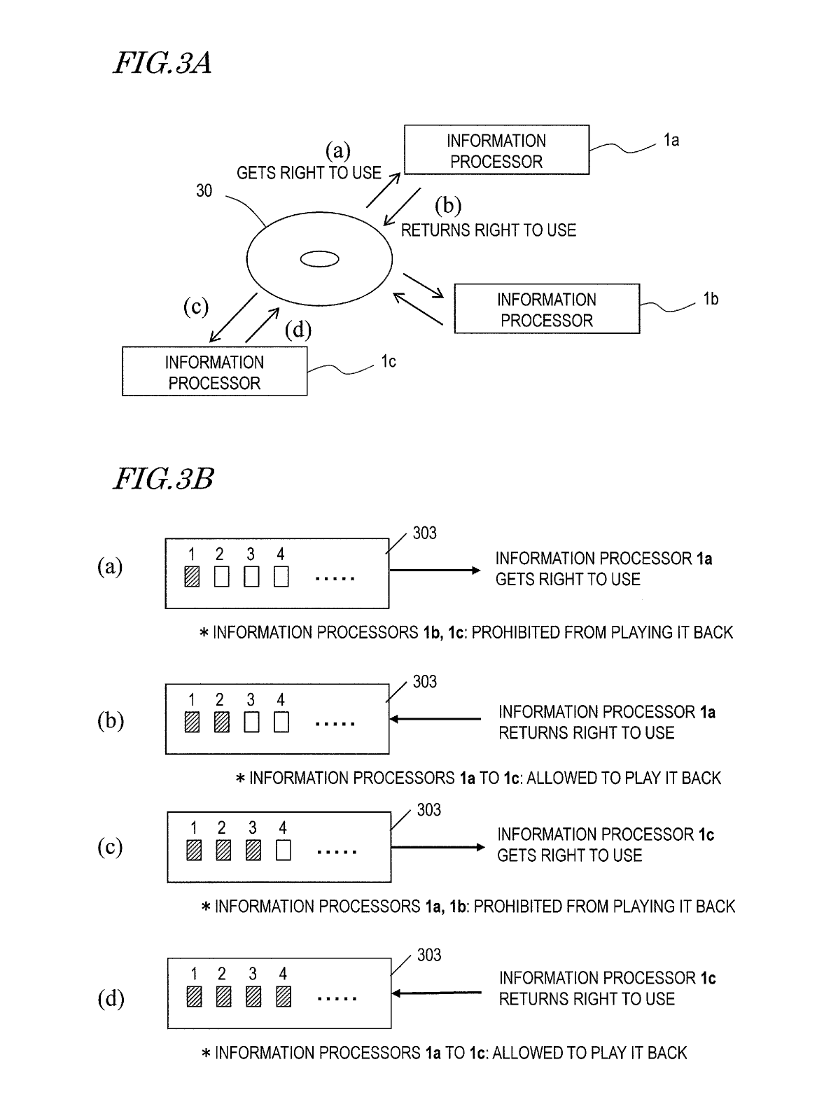

FIG. 3A is a schematic representation illustrating an exemplary situation where the right to use is gotten and returned between the first storage medium 30 and the multiple information processors 1a to 1c. As an example, the processing steps (a) through (d) shown in FIG. 3A will be described.

Specifically, the information processor 1a may get the right to use from the first storage medium 30 in the processing step (a) but may return it to the first storage medium 30 in the processing step (b). Also, the information processor 1c may get the right to use from the first storage medium 30 in the processing step (c) but may return it to the first storage medium 30 in the processing step (d).

Portions (a) through (d) of FIG. 3B illustrate what has been added to the write-once area 303 on the first storage medium 30 in respective situations where the processing steps (a) through (d) shown in FIG. 3A have been performed.

Specifically, in the situation shown in portion (a) of FIG. 3B, the information processor 1a has gotten the right to use. In that case, the right-to-use information is written on Section #1 of the write-once area 303 on the first storage medium 30. Since the right-to-use information has been written on that Section #1, it can be seen that the right has been transferred for the first time. The right-to-use information itself will be described in detail later.

In this case, the information processor 1a can copy the content on the first storage medium 30 onto the second storage medium 205 and can also play back that content. Meanwhile, neither of the other information processors 1b and 1c may play back the content on the first storage medium 30.

In the situation shown in portion (b) of FIG. 3B, the information processor 1a has returned the right to use to the first storage medium 30. In that case, the right-to-use information is added to Section #2. The information processors 1a through is cannot copy the content on the first storage medium 30 onto the second storage medium 205 but can still play back that content.

In the situation shown in portion (c) of FIG. 3B, the information processor 1c has gotten the right to use. In that case, the right-to-use information is added to Section #3 of the write-once area 303 on the first storage medium 30. Since the right-to-use information has been written on that Section #3, it can be seen that the right has been transferred for the third time. The information processor 1c can copy the content on the first storage medium 30 onto the second storage medium 205 and also can play back that content. Meanwhile, neither of the other information processors 1a and 1b may play back the content on the first storage medium 30.

In the situation shown in portion (d) of FIG. 3B, the information processor 1c has returned the right to use to the first storage medium 30. In that case, the right-to-use information is added to Section #4. The information processors 1a through 1c cannot copy the content on the first storage medium 30 onto the second storage medium 205 but can still play back that content.

As described above, every time the right to use is transferred between the first storage medium 30 and the information processor, the write-once area 303 on the first storage medium 30 is updated. However, once the right-to-use information has been added to the very last Section #N, the right to use the content can no longer be transferred. In that case, the information processors 1a through 1c cannot copy the content on the first storage medium 30 onto the second storage medium 205 but can still play back that content.

As can be seen from the foregoing description, by physically leaving the history of the right-to-use information on the write-once area 303 that has a finite area length on the first storage medium 30, an upper limit can be set to the number of times of transfers. It can also be seen that if the right-to-use information has been added for the zeroth or even-numbered times, the right to use should be set for the first storage medium 30 currently but that if the right-to-use information has been added for an odd-numbered times, any of those information processors should have gotten the right to use currently.

Next, it will be described how to get the processing of generating the right-to-use information done.

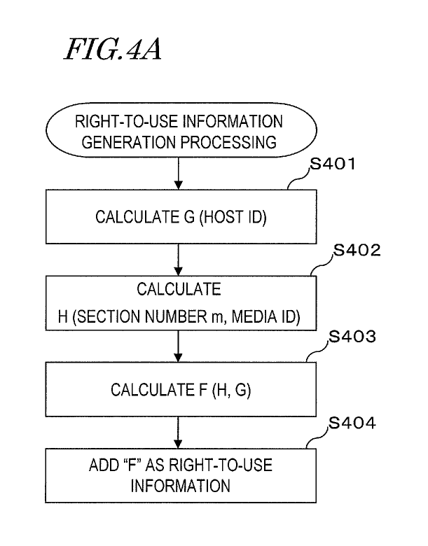

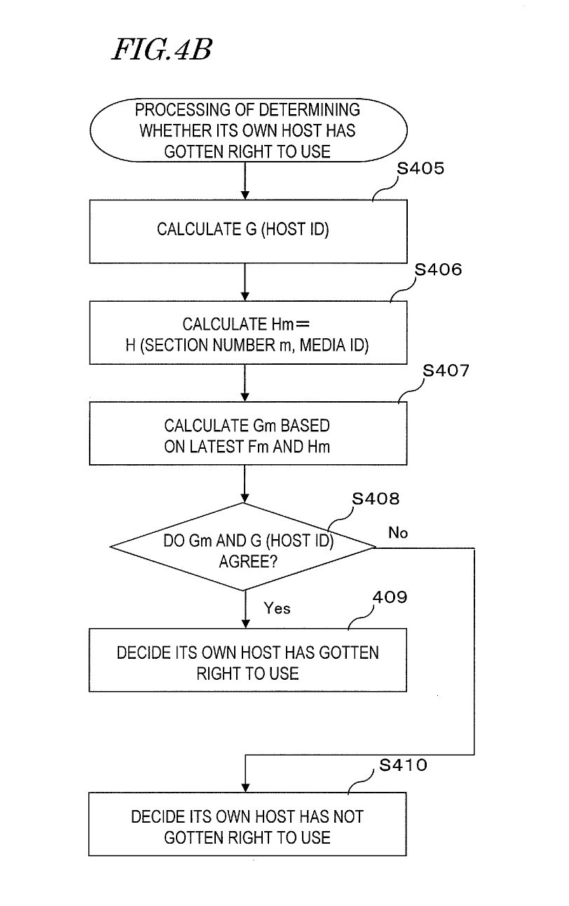

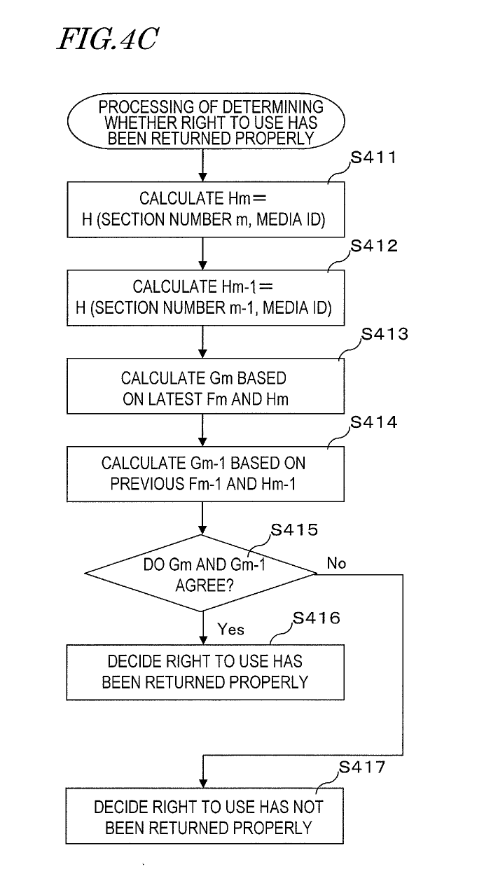

FIG. 4A is a flowchart showing the procedure of generating the right-to-use information to add.

First of all, in Step S401, the right-to-use information generating section 204 calculates a function G (host ID) based on the host ID 201 that has been read. The function G may be a keyed hash function, for example. The function G may be defined by each host device 20 following its own rule. However, it is preferred that the function G be selected so that a third party that does not know the rule cannot presume the G value easily. Besides, the host ID does not have to be calculable back based on the G value.

Next, in Step S402, the right-to-use information generating section 204 calculates a function H (section number m, media ID) based on the media ID 302 and the section number 304 in the write-once area 303 that have been read. The function H may also be a keyed hash function, for example. The function H may be defined by every host device following the same rule. Alternatively, the rule may be changed with the range of the media ID 302. It is preferred that the function H be selected so that a third party that does not know the rule cannot presume the H value easily. However, the media ID does not have to be calculable back based on the H value.

As the keyed hash function which may be used for functions G, and H, a function to perform processing on HMAC (keyed-hashing for message authentication code) is known.

Next, in Step S403, the right-to-use information generating section 204 calculates a function F (H, G). In this case, the function F is a function for performing XOR operation, for example. The function F may be defined by every host device following the same rule. The G value needs to be calculable back based on the F and H values. And this result of calculation is used as the right-to-use information.

Then, in Step S404, the right-to-use information writing section 104 adds the F (H, G) function that has been calculated by the right-to-use information generating section 204 to an unrecorded section 304 with the smallest section number in the write-once area 303.

In this manner, the right-to-use information generating section 204 can generate the right-to-use information by a predetermined function that uses, as variables, the media ID of the first storage medium 30, the host ID, and the number of times M that the right to use the content has been transferred (which is equivalent to the section number m). As a result, generation management can be carried out on the right to use a content with the number of times that the content has been transferred taken into account.

Next, it will be described how to decide, by reference to that right-to-use information, what information processor has gotten the right to use now. It will also be described how to determine whether or not the right to use has been returned properly.

FIG. 4B is a flowchart showing the procedure of the processing of determining, by reference to the right-to-use information that has been written on the write-once area 303 on the first storage medium 30, whether or not its own host device has gotten the right to use now.

First of all, in Step S405, the right-to-use decision section 203 calculates the function G (host ID) based on the host ID 201 that has been read. Next, in Step S406, the right-to-use decision section 203 calculates an Hm value=H (latest section number m, media ID) based on the latest section number m and the media ID that have been read. This is a value that should be generated when its own device should get the right to use.

Subsequently, in Step S407, the right-to-use decision section 203 reads the latest piece of section information Fm from the write-once area 303 and calculates a Gm value based on the Fm that has been read and the Hm value described above. In this description, this “latest piece of section information Fm” means the latest piece of right-to-use information that has been written most lately on a recorded section of the write-once area 303.

Then, in Step S408, the right-to-use decision section 203 determines whether or not the Gm value thus obtained agrees with the G (host ID). If the answer is YES, the right-to-use decision section 203 decides in Step S409 that its own host has gotten the right to use. Otherwise, the right-to-use decision section 203 decides in Step S410 that its own host has not gotten the right to use.

In this manner, the information processor of this preferred embodiment can determine, by reference to the right-to-use information, whether or not its own host has gotten the right to use now.

FIG. 4C is a flowchart showing the procedure of the processing of determining, by reference to the right-to-use information that has been written on the write-once area 303 on the first storage medium 30, whether or not the right to use has been returned properly.

First of all, in Steps S411 and S412, the right-to-use decision section 203 calculates an Hm value=H (latest section number m, media ID) and an Hm−1 value=H (section number m−1, media ID), respectively. Next, the right-to-use decision section 203 reads the latest piece of section information Fm and the previous piece of section information Fm−1 from the write-once area, and calculates a Gm value based on the Fm and Hm values in Step S413 and a Gm−1 value based on the Fm−1 and Hm−1 values in Step S414, respectively.

Then, in Step S415, the right-to-use decision section 203 determines whether or not the Gm−1 value thus obtained agrees with the Gm value. If the answer is YES, the right-to-use decision section 203 decides in Step S416 that the right to use has been returned properly. Otherwise, the right-to-use decision section 203 decides in Step S417 that the right to use has not been returned properly.

In this manner, the information processor of this preferred embodiment can determine, by reference to the right-to-use information, whether or not the right to use has been returned properly.

Hereinafter, it will be described exactly how the information processor 1 of this preferred embodiment makes a decision on the right to use a content.

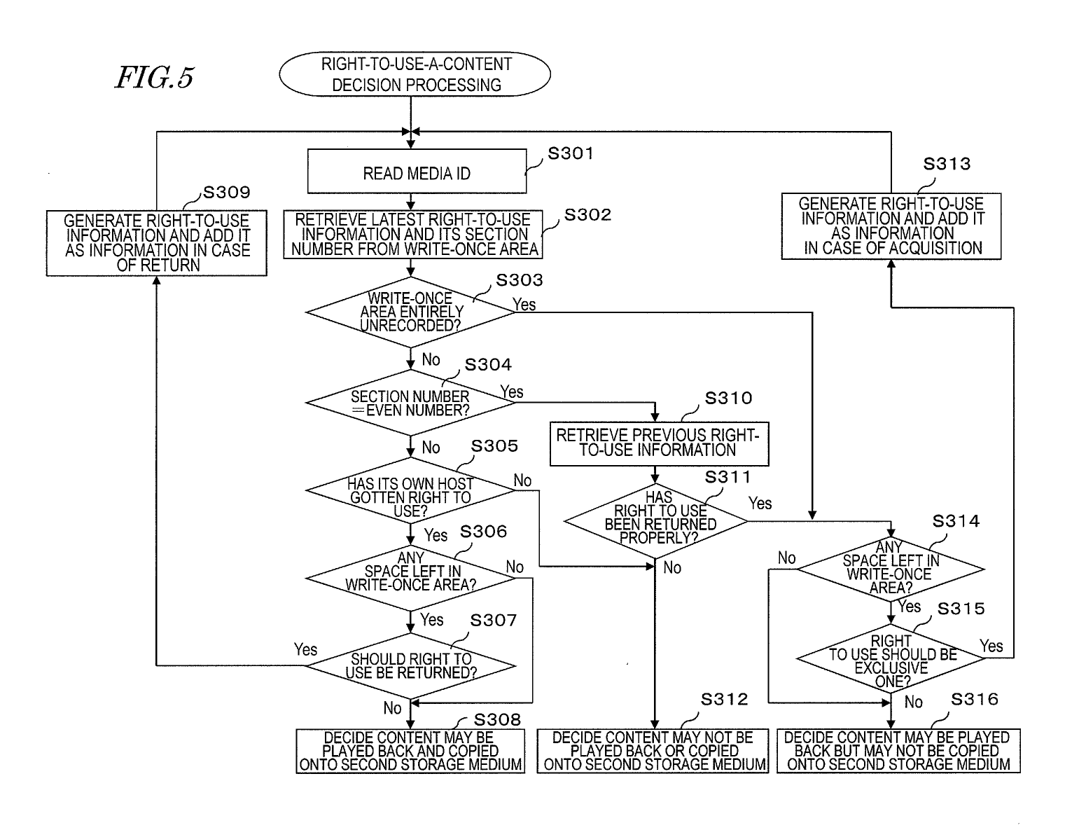

FIG. 5 is a flowchart showing the procedure in which the host device 20 makes a decision on the right to use a content. Specifically, this flowchart shows the procedure of determining whether or not the content may be played back and the procedure of determining whether or not the content that has been copied onto the second storage medium may be used. The processing steps shown in FIG. 5 are carried out by the CPU 21 of the host device 20.

The host device 20 gets the media ID 302, the latest piece of right-to-use information that has been added most lately to the write-once area 304, and its section number from the drive device 10, and performs an appropriate series of processing steps shown in FIG. 5 depending on whether its own host device has gotten the right to use, whether the right to use should be gotten (if the answer is NO) and whether the right to use should be returned (if the answer is YES). During this process, the host device 20 may generate the right-to-use information and add that information to the write-once area in some cases.

By performing the processing shown in FIG. 5, when a decision needs to be made on the right to use a content, the host device 20 can determine in which of the following three states (1) to (3) it is in:

(1) The state to be detected in Step S308, i.e., gotten-by-its-own-host state in which the content may be played back and copied onto the second storage medium;

(2) The state to be detected in Step S312, i.e., gotten-by-another-host or right-to-use-returned-improperly state in which the content may not be played back or copied onto the second storage medium; and

(3) The state to be detected in Step S316, i.e., right-to-use-returned or initial state in which the content may be played back but may not be copied onto the second storage medium.

To decide that this is the “gotten-by-its-own-host” state (1), the media ID should be read in Step S301 first, the latest piece of right-to-use information and its section number should be retrieved Step S302 next, and then no part of the write-once area should turn out to be unrecorded in Step S303.

After that, if the section number has turned out to be an odd number in Step S304 and if it turns out in Step S305 that its own host has gotten the right to use, then the host device 20 may decide that this is the “gotten-by-its-own-host” state (1).

On the other hand, the host device 20 may decide that this is the “gotten-by-another-host or right-to-use-returned-improperly” state (2) in any of the following two situations. Specifically, in one situation, after the processing steps S301 through S303 have been performed, the section number should turn out to be an odd number in Step S304, and then the host device 20 should decide in Step S305 that its own host has not gotten the right to use. In the other situation, after the processing steps S301 through S303 have been performed, the section number should turn out to be an even number in Step S304, and then the host device 20 should decide in Step S311 that the right to use has not been returned properly.

Likewise, the host device 20 may also decide that this is the “right-to-use-returned or initial” state (3) in any of the following two situations. Specifically, in one situation, after the processing steps S301 through S303 have been performed, the section number should turn out to be an even number in Step S304, and the host device 20 should decide, in Step S311 after the next processing step S310 has been performed, that the right to use has been returned properly. In the other situation, after the processing steps S301 and S302 have been performed, every part of the write-once area 303 should turn out to be unrecorded in Step S303.

In this example, among the processing steps S301 through S316 included in the flowchart shown in FIG. 5, the processing step S305 is the step of determining whether or not its own device has gotten the right to use. As this processing step has already been described with reference to FIG. 4B, a detailed description thereof will be omitted herein.

Also, the processing step S311 is the step of determining whether or not the right to use has been returned properly. As this processing step has already been described with reference to FIG. 4C, a detailed description thereof will be omitted herein.

Furthermore, the processing steps S309 and S313 are the steps of generating and adding the right-to-use information. As these processing steps have already been described with reference to FIG. 4A, a detailed description thereof will be omitted herein.

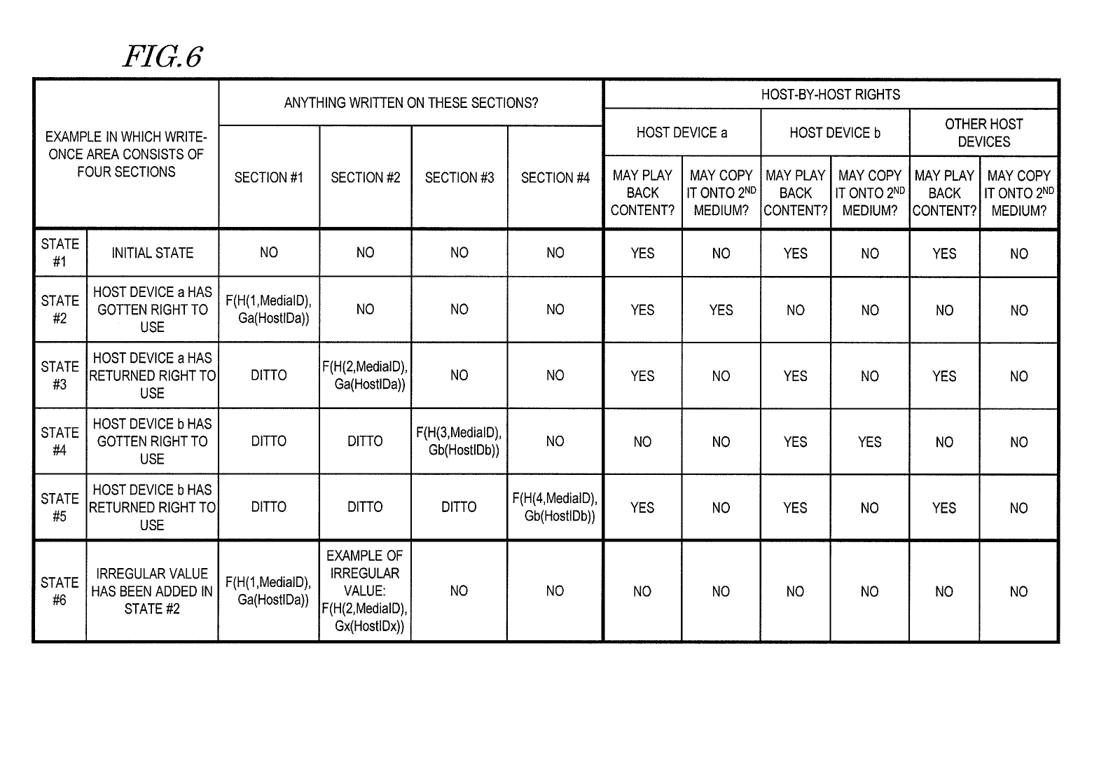

Next, it will be described with reference to FIG. 6 exactly how and where the right to use a content that has been written on the first storage medium by the information processor of this preferred embodiment is transferred.

In the example shown in FIG. 6, the write-once area 303 is supposed to consist of four sections.

FIG. 6 shows how the information to add will change, and what kind of processing may be performed by the host device, as the right to use is gotten and then returned.

Specifically, State #1 is an initial state in which no right-to-use information has been written yet on the first storage medium 30. This state belongs to the “right-to-use-returned or initial” state. In this State #1, the content may be played back by every host device with the ability to play back the content from the first storage medium 30, but the content that has been copied onto the second storage medium may not be used by any of those host devices.

State #2 is a state in which Host Device a has gotten the right to use. That is why as far as that Host Device a is concerned, this is the “gotten-by-its-own-host” state. The content may be played back, and the content that has been copied onto the second storage medium 205 may be used, just by that host device in this state. As for the other host devices including Host Device b, however, this is the “gotten-by-another-host or right-to-use-returned-improperly” state. That is why the content may not be played back, and the copied content may not be used, by any of the other host devices in this state.

State #3 is a state in which Host Device a has returned the right to use and belongs to the “right-to-use-returned or initial” state again. In this state, the content may be played back by every host device, but the content that has been copied onto the second storage medium may not be used by any of those host devices.

State #4 is a state in which Host Device b has gotten the right to use. That is why as far as that Host Device b is concerned, this is the “gotten-by-its-own-host” state. The content may be played back, and the content that has been copied onto the second storage medium 205 may be used, only by that host device in this state. As for the other host devices including Host Device a, however, this is the “gotten-by-another-host or right-to-use-returned-improperly” state. That is why the content may not be played back, and the copied content may not be used, by any of the other host devices in this state.

State #5 is a state in which Host Device b has returned the right to use and belongs to the “right-to-use-returned or initial” state once again. In this state, the content may be played back by every host device, but the content that has been copied onto the second storage medium may not be used by any of those host devices.

Since the write-once area 303 consists of four sections in this example, no host devices can newly get the right to use anymore. State #6 is a state in which not the regular right-to-use information that has been generated by Host Device a but an irregular F value has been written in State #2 and belongs to the “gotten-by-another-host or right-to-use-returned-improperly” state. That is why the content may not be played back, and the copied content may not be used, by any of the host devices in this state. And no host devices can newly get the right to use, either in such a state.

In the preferred embodiment of the present invention described above, the first storage medium on which a content with copyright to be protected is stored is supposed to be a write-once optical disc with a write-once area. However, this is just an example of the present invention. Alternatively, the copyright protection generation management may also be carried out using the number of times M that the content has been transferred instead of the number m of the section to which the right-to-use information is added.

In addition, if the number of times M that the content has been transferred is used, a content, of which the copyright should be protected, may be written on any of various rewritable storage media, including optical discs such as a BD-RE and flash memories such as an SD memory card, instead of the write-once optical disc and its copyright protection generation management may be carried out.

Nobody has ever imagined that the right-to-use information could fail to be written perfectly on an optical disc. However, some disc defects could be caused due to a sudden power cut while the optical disc is either being manufactured or being used by the user. In such a situation, the section 304 to which the right-to-use information could be added might be unusable.

That is why if the section 304 on which the right-to-use information has been written last time is a defective area, playback of the content from that storage medium may be prohibited. In that case, the processing may be performed adaptively depending on whether the number of times M of valid transfers is an odd number or an even number. It should be noted that the information processor 1 does not have to decide whether or not there is any defective area. If the information processor 1 finds that information cannot be retrieved normally from a certain section, then the processor 1 may decide that there be a defective area in that section.

In the foregoing description of preferred embodiments, the right-to-use information is supposed to be calculated and the right-to-use decision processing is supposed to be performed using the host ID 201 and the media ID 302. However, this is just an example of the present invention. Optionally, a method for calculating the same right-to-use information without using any media ID may also be adopted.

The present invention provides an information processor that carries out a copyright protection generation management on some package medium such as an optical disc, in particular. However, this information processor is broadly applicable for use in a player to play back a movie, an e-book terminal device to read an e-book, and various other electronic devices.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Applications No. 2011-001000 filed on Jan. 6, 2011, the entire contents of which are hereby incorporated by reference.

What is claimed is:

1. An information processor for operating in accordance with a right to use a content that is stored on a first storage medium,
wherein the first storage medium has:
a write-once area on which right-to-use information is writable a limited number of times; and
a data area on which data of the content is stored, and wherein the information processor comprises:
a second storage medium;
a right-to-use information generating section, which generates right-to-use information indicating whether the first storage medium or the second storage medium holds the right to use the content; and
a drive device that writes the right-to-use information on the write-once area.

2. The information processor of claim 1, wherein if any preceding right-to-use information has already been written on the write-once area, the drive device writes the right-to-use information that has been generated by the right-to-use information generating section on the write-once area without modifying the preceding right-to-use information.

3. The information processor of claim 2, further comprising a memory that retains host information to be allocated to the information processor as its own information,
wherein the right-to-use information generating section generates, based on the host information and the number of times that the right-to-use information has been added to the write-once area, a piece of right-to-use information indicating that the second storage medium holds the right to use the content.

4. The information processor of claim 1, wherein the drive device is able to retrieve right-to-use information that has been written on the write-once area, and wherein the information processor further includes a decision section that determines, based on the right-to-use information that has been retrieved by the drive device, whether the first storage medium or the second storage medium holds the right to use the content.

5. The information processor of claim 4, further comprising a memory that retains host information to be allocated to the information processor as its own information,
wherein the decision section generates a first value based on the host information,
also generates a second value based on the latest piece of right-to-use information that has been written on the write-once area most lately and the number of times that the right-to-use information has ever been written on the write-once area,
determines whether or not the first and second values agree with each other, and
decides that the information processor itself has gotten the right to use the content if the first and second values agree with each other.

6. The information processor of claim 1, wherein the drive device is able to retrieve right-to-use information that has been written on the write-once area, and
wherein the information processor further includes a decision section that determines, based on the number M of pieces of valid right-to-use information that has been retrieved by the drive device, whether the first storage medium or the second storage medium holds the right to use the content.

7. The information processor of claim 1, further comprising a control section that either permits or prohibits playing back the content,
wherein the drive device is able to retrieve right-to-use information that has been written on the write-once area, and
wherein if the drive device has failed to retrieve the latest piece of the right-to-use information properly, the control section prohibits playing back the content.

8. The information processor of claim 3, wherein an identifier for identifying the first storage medium unequivocally is stored on the first storage medium, and
wherein by using the identifier as well, the right-to-use information generating section generates the right-to-use information indicating that the second storage medium holds the right to use the content.

9. The information processor of claim 8, wherein the right-to-use information generating section retains first, second and third functions that have been defined in advance, and
wherein the right-to-use information generating section obtains two values by substituting the host information into the first function and by substituting the identifier of the first storage medium and another value indicating the number of times that the right-to-use information has been written on the write-once area into the second function, respectively, and then substitutes those two values into the third function to generate the right-to-use information.

10. The information processor of claim 5, further comprising a control section that either permits or prohibits copying the content onto the second storage medium,
wherein if the decision section has decided that the information processor itself has gotten the right to use the content, the control section permits copying the content onto the second storage medium.
